(19) United States
(12) Patent Application Publication
(10) Pub. No.: US 2020/0381706 A1
(43) Pub. Date: Dec. 3, 2020

(54) DEFECT-FREE GRAPHENE CONTAINING MATERIAL FOR ELECTROCHEMICAL STORAGE DEVICES AND METHODS FOR MAKING

(71) Applicant: Sparkle Power LLC, Rochester, NY (US)

(72) Inventors: Wei Liu, Chengdu (CN); David Mitlin, Lakeway, TX (US)

(21) Appl. No.: 16/889,239

(22) Filed: Jun. 1, 2020

Related U.S. Application Data
(60) Provisional application No. 62/855,084, filed on May 31, 2019.

(51) Int. Cl. H01M 4/133; H01M 4/38; H01M 4/70; H01M 4/66; H01M 4/62

(52) U.S. Cl. CPC H01M 4/133; H01M 4/386; B82Y 30/00; H01M 4/667; H01M 4/623; H01M 4/70

(57) ABSTRACT

A material for use as an electrode in an electrochemical storage device, the material includes at least one layer of defect-free graphene; an active phase proximate at least one surface of the at least one layer of defect-free graphene; and a binder system and methods for making the same.

### CROSS-REFERENCE TO RELATED APPLICATIONS

The instant application claims priority to co-pending U.S. Provisional Application No. 62/855,084, filed on May 31, 2019, and entitled “Composite Battery Electrodes with High Coulombic Efficiency and Cyclability”. The entirety of the aforementioned provisional application is incorporated by reference in its entirety.

### FIELD OF THE INVENTION

The present invention relates to defect-free graphene containing materials, and more particularly to defect-free graphene containing materials for electrochemical storage devices.

### BACKGROUND OF THE INVENTION

Lithium-ion batteries (LIBs) are becoming universal in many energy storage applications such as, for example, mobile electronics and electric vehicles. The rapidly growing demand for high energy density LIBs has triggered numerous efforts on developing new electrode materials. Silicon-based anode material have drawn wide interest as Si offers a very high reversible capacity, low electrochemical potential (0-0.4V vs Li/Li⁺), as well as inherent advantages of abundant reserves and low-cost. However, several drawbacks, including inherently low electrical conductivity and sluggish Li diffusion kinetics have impeded silicon's wide application in LIB anodes. A challenge for silicon arises from the large and unavoidable volume expansion (more than 300%) during battery cycling, which can result in electrode pulverization, loss of inter-particle electrical pathways, and repeated side reactions with the electrolyte leading to an unstable solid electrolyte interphase (SEI).

Extensive studies have been carried out to pave the way for applying silicon anodes for LIB applications. Many pioneering advancements report exciting progresses on nanoscale Si or Si nanocomposite structures. It is found that nanostructured silicon can offer not only shortened Li diffusion distances but also much improved tolerance to the large volume expansion, leading to superior rate and cycle performance. Moreover, incorporating silicon nanoparticles (Silicon nanoparticles) into a conductive carbon host has been demonstrated to further improve performance through both enhanced electrical conductivity and structural stability. Composite structures of graphene and silicon have been intensively studied, showing promising advancements. However, traditional physical mixing (ball milling, solution mixing, etc.) graphene with silicon faces challenges of obtaining uniform dispersion and well-tuned hierarchical composite structure.

Building on these existing and encouraging results, one can conclude that the role of an optimum host for silicon nanoparticles (SiNP's) and related structures is the following: A functional host should possess an elastically flexible and electrically conductive structure, which uniformly surrounds the silicon nanoparticles to accommodate lithiation volume expansion and stabilize the solid electrolyte interphase (SEI). To achieve this, the host should also possess sufficient chemical bonding with both the silicon nanoparticles and the polymer binder. Previous studies using nanostructured silicon hybrids in combination with advanced binder systems have shown progress. Moreover challenges remain in terms of facile of integration of such approaches directly into the electrode synthesis process, accounting for cost and scalability. Microstructural design of the overall electrode architecture beyond the dispersion of the active material per se, may be the under-appreciated key for Si-based lithium ion battery (LIB) performance. Traditional binder systems like poly(vinylidene fluoride) (PVDF) exhibit poor adhesion to the Si-particles. Synergism between the active materials and the binder has drawn some attention. Some advanced binder systems (CMC, PAA, alginate etc.) can hydrogen bond with the hydroxyl groups (—OH) on the Si surface, providing an additional reinforcement to stabilize the electrodes against cycling-induced failure. However, the protic species (—OH, —COOH etc.) are also known to react with LiPF₆ salt and then initiate autocatalytic side reactions of the carbonate electrolyte, causing problems such as gas evolution, electrolyte dry-out and impedance increases.

As a prevailing anode for LIBs, graphite serves as an ideal host for silicon nanoparticles. It possesses excellent electrical conductivity and forms stable SEI in carbonate electrolyte. An oxidation-reduction two-step method, e.g. Hummers' method, could open the interlayer spacing of graphite and yield reduced graphene oxide (r-GO). However, r-GO is rich in structural and chemical defects such as nanopores and residual oxygen groups, which are detrimental to solid electrolyte interphase (SEI) stability.

### SUMMARY OF THE INVENTION

One aspect is directed to a novel method that introduces am active phase to defect free graphene. The active phase can be attached to the defect free graphene and/or a binder system. The defect-free graphene can be attached to the binder system and/or the active phase. The binder system can be attached to the defect free graphene and/or the active phase.

In one aspect, the invention is directed to a novel method that introduces silicon nanoparticles into expanded layers of graphene while introducing minimal defects onto graphene layers. In parallel, a facile approach is employed to chemically tether these nanocomposites to the carboxymethyl cellulose (CMC) binder particles using epoxy functional groups, creating robust electrodes capable of high rate—high cycling performance.

Another aspect is directed to a material for use as an electrode in an electrochemical storage device, the material comprising: at least one layer of defect-free graphene; an active phase proximate at least one surface of the at least one layer of defect-free graphene; and a binder system, wherein at least one of: (a) the at least one layer of defect-free graphene is attached to the active phase, (b) the active phase is attached to the binder system, and (c) the defect-free graphene is attached to the binder system.

In another aspect, the invention is directed to a method for making the aforementioned material.

In another aspect, the invention is directed to a method for making an active phase-containing defect-free graphene material, the method comprising: providing graphite to a non-oxidative exfoliation process to obtain expanded graphite; and simultaneously during the exfoliation process, introducing an active phase to form an active phase-containing defect-free graphene.

These and other embodiments are discussed in more detail herein.

### BRIEF DESCRIPTION OF THE DRAWINGS

FIG. 1 shows a schematic illustration of a material according to embodiments disclosed herein.

FIG. 2 shows an electrochemical storage device according to embodiments disclosed herein.

FIG. 3 shows a schematic of a process according to embodiments disclosed herein.

### DETAILED DESCRIPTION OF THE INVENTION

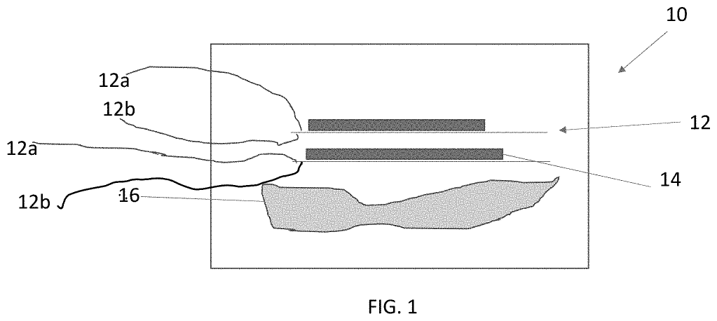

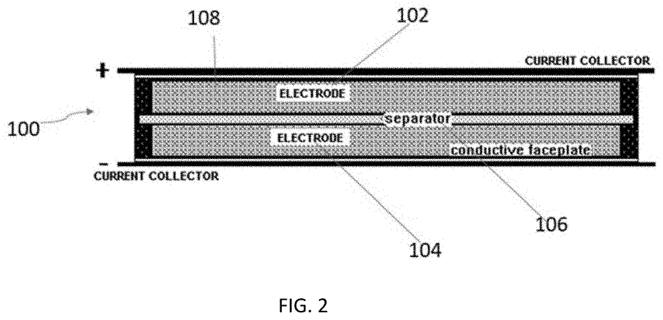

In one aspect, the present invention provides a material 10, shown schematically in FIG. 1. The material 10 can be used as an electrode in an electrochemical storage device, for example, as a cathode or as an anode. Examples of electrochemical energy storage devices 100, as shown in FIG. 2, include, but are not limited to, batteries, capacitors, supercapacitors, ultracapacitors, symmetric capacitors, hybrid capacitors, and the like. Energy storage device 100 includes at least one electrode. In the embodiment shown in FIG. 2, the device 100 includes a cathode 102, an anode 104, a separator 106, and an electrolyte 108. Separator 106 and electrolyte 108 are known in the art and acceptable to use in the device 100. In one embodiment, the electrolyte 108 is an organic electrolyte or an aqueous electrolyte. In one embodiment, the electrolyte 108 is an organic electrolyte that includes 1.0 M tetraethylammonium tetrafluoroborate (TEATFB) salt in acetonitrile (ACN) solvent.

Turning back to FIG. 1, the material 10 includes at least one layer of defect-free graphene 12, an active phase 14, and a binder system 16. As shown in FIG. 1, there are two layers of defect-free graphene, however the invention is not limited in this regard as the material 10 can include only 1 layer of defect-free graphene 12, or many layers of defect-free graphene, e.g., more than 2 layers of defect-free graphene. In one embodiment, the material 10 includes 2 layers of defect-free graphene. In another embodiment, the material 10 includes 3 layers of defect free graphene. In another embodiment, the material 10 includes more than 3 layers of defect free graphene. In a multi-layer material 10, the space between each layer 12 is microns wide

Each defect-free graphene layer 12 includes more than one surface. As shown in FIG. 1, the defect-free layer 12 includes surfaces 12a, 12b. In multi-layer materials, one surface (shown as surface 12b in FIG. 1) of one layer 12 is opposite a surface of another layer 12. Thinking of this conceptually, it will be appreciated that each layer has a “top” surface, and each layer has a “bottom” surface. As shown in FIG. 1, the active phase 14 is proximate at least one surface 12a, 12b of the at least one defect-free grapheme layer 12. The term “proximate” as used herein, means near, next to, on top of, integrated with, or in otherwise close proximity.

In one embodiment of the material 10 the at least one layer of defect-free graphene 12 is attached to the active phase 14. In another embodiment, the active phase 14 is attached to the binder system 16. In another embodiment the at least one layer of defect-free graphene 12 is attached to the binder system 16. It is contemplated that the material 10 can include more than one of the aforementioned attachments. The term “attachment” or “attached” as used herein indicates a chemical or mechanical bond of one portion of the material 10 to another portion of the material 10. In one embodiment, the portions of material 10 are attached chemically. In another embodiment, the portions of material 10 are attached mechanically. In another embodiment, the portions of material 10 are attached chemically and mechanically. A preferable attachment is by way of an epoxy “tether” that permits chemical and/or mechanical attachment. Epoxy

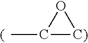

tethers are achieved, in one embodiment, by using a silane coupling agent (SCA, γ-(2,3-epoxypropoxy) propytrimethoxy silane) during the manufacture of material 10. The tethers can create a chemical bond and/or a physical (i.e., mechanical) connection between the portions of the material 10. The tethers facilitate the formation of the active phase-containing defect-free graphene hybrid material. In an active phase-containing defect-free graphene hybrid material, the attachment of the active phase to both the binder system 16 and the defect-free graphene layer 12, results in a highly robust material that will resist cycling-induced decrepitation.

In another embodiment, the attachment of the active phase 14 to the defect-free graphene layer 12 is by electrostatic interactions. Electrostatic interactions are a result of the positively charged defect-free graphene and the negatively charged active phase 14. The invention is not limited in this regard as electrostatic interactions can also occur between the active phase 14 and the binder system 16 and/or between the binder system 16 and the defect-free graphene layer 12.

The defect-free graphene (also sometimes referred to herein as “pristine graphene”) in the layers 12 is graphite that has undergone a gentle exfoliation process that results in a layer of graphene that does not have defects (i.e., impurities such as, e.g., oxygen) and has a highly ordered graphene structure. The defect-free graphene is distinct from the amorphous highly broadened ring patterns corresponding to classed reduced graphene oxide (rGO) or other highly defective “graphene-like” materials. In one embodiment, the defect-free graphene layer 12 includes “ruffled” or wavy edges.

According to one embodiment, the active phase 14 is any active material that is used in electrochemical energy storage devices and can take any form, e.g., a film, particles, and the like. In one embodiment, the active phase 14 includes a plurality of active nanoparticles. In one embodiment, the active nanoparticles are silicon, germanium, metals, sulfides, phosphides, selenides, nitrides, oxides, and/or ceramics. In one particular embodiment, the active phase 14 is a plurality of active nanoparticles that are silicon nanoparticles.

The active phase 14 is present in the material 10 in an amount sufficient to use the material 10 in the desired application. In one embodiment, the active phase 14 is active nanoparticles that are provided in a mass loading into the material in an amount sufficient to improve certain aspects of electrochemical storage devices. In one embodiment, the active nanoparticles are present in high mass loading in the material 10. In a particular embodiment, the active nanoparticles are silicon nanoparticles present in high mass loading in the material 10. In a particular embodiment, the silicon nanoparticles are mass loaded in the material 10 at least at about 40%, at least about 45%, at least about 47%, at least about 48%, or at least about 50%. In a particular embodiment, material 10 includes a plurality of silicon nanoparticles present at a mass loading of at least 47%.

It is contemplated that the binder system 16 of material 10 can be any known binder system that is useful in electrochemical storage devices. In one embodiment, the binder system 16 is selected from carboxymethyl cellulose, alginate, polyacrylic acid, Polyvinylidene fluoride (PVDF) and/or Styrene-Butadiene Rubber. In a particular embodiment, the binder system 16 is carboxymethyl cellulose (CMC).

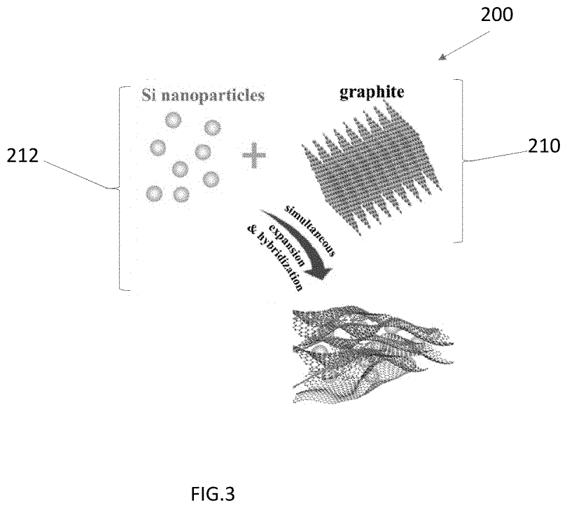

In another aspect, the invention is directed to a method 200 for making an active phase-containing defect-free graphene material, e.g., the material 10. As shown in FIG. 3, the method 200 includes a step 210 of providing graphite to a non-oxidative exfoliation process to obtain expanded graphite. As shown in a parallel step 220, simultaneously during the exfoliation process, an active phase 16 is introduced to form an active phase-containing defect-free graphene material, e.g., material 10.

In a specific example of the method 200, a (NH₄)₂S₂O₈ salt is added to a sealed beaker containing H₂SO₄/Oleum solution until it is completely dissolved. Then graphite powder is added step-wise, the entire solution then being transferred to a 60° C. water bath and stirred. Due to its greatly weakened interplane Van der Waals interactions, the expanded graphite is then easily exfoliated into defect-free graphene by 5 minutes of bath-sonication at room temperature in NMP solvent. This exfoliation/expansion method avoids the involvement of harsh conditions (high temperature, microwave and tip-sonication, etc.), offering inherent simplicity and potential cost-effectiveness.

As detailed in the examples herein, the high orderliness of the defect-free graphene leads to excellent early and steady-state cycling Coulombic efficiency (CE) in silicon-containing defect-free graphene material (referred to as Si-pG herein) and silicon-containing defect free hybrid materials (having the aforementioned tethers, and indicated as (E-Si-pG)) anodes when tested against Li/Li⁺. The baseline consisting of identical silicon nanoparticles but hosted by rGO (Si-rGO) is shown to perform much worse. Unlike Si-pG and E-Si-pG, the baseline Si-rGO demonstrates high levels of CE loss due to severe SEI formation, typical for defective carbon anodes in carbonate electrolytes. In the case of the Si-pG, the material is formed simultaneously to the graphite exfoliation/expansion process: The silicon nanoparticles and graphite are co-added to the (NH₄)₂S₂O₈ reagent. During synthesis, the graphite expansion gives rise to numerous graphene surfaces. For the case of Si-pG, the silicon is already in solution when this is occurring, allowing for its uniform adsorption and distribution on these fresh (0002) surfaces.

During synthesis, the graphite expansion gives rise to numerous graphene surfaces, discussed in more detail above. For the case of Si-pG, the silicon is already in solution when this is occurring, allowing for its uniform adsorption and distribution on these fresh (0002) surfaces. One may then consider synthesis of Si-pG as an in-situ process. The dispersion and attachment of the silicon nanoparticles on the graphene surfaces is driven by electrostatic interactions.

As one skilled in the art would recognize, the silicon nanoparticles are negatively charged due to their oxidized surface (Si—OH and Si—O—Si bonds). These oppositely charged states facilitate rapid silicon surface attachment on defect-free graphene at high mass loading. As a result of surface tension the graphene layers also wind up wrinkling during the expansion. This intrinsic in-parallel occurring corrugation behavior provides geometric anchoring sites for the silicon particles. In the dry state, there may be limited hydrogen bonding between the silicon surfaces and slightly oxidized p-G. However, the interaction should be primarily physical given the relatively low oxygen content p-G as compared to classical r-GO.

In method 200, it is contemplated that the active phase is as defined above. In a particular embodiment of method 200, the active phase is a plurality of active nanoparticles, in particular, silicon nanoparticles. In one embodiment of the method 200, the plurality of silicon nanoparticles are present in the material at a mass loading of at least 47%.

In another embodiment, the method 200 further includes a subsequent step (not illustrated) of adding a binder system 16 to the active phase-containing defect-free graphene material. In a further embodiment, after the binder system is added, the method 200 includes a further subsequent step of adding a silane surface treatment. A silane surface treatment (also referred to as “a silane coupling agent” (“SCA”)) includes γ-(2,3-epoxypropoxy) propytrimethoxy silane). The silane surface treatment facilitates the attachment of the at least one layer of defect-free graphene to the active phase, and/or the attachment of the active phase to the binder system, and/or the defect-free graphene to the binder system.

These embodiments are further discussed in the Examples herein.

### EXAMPLES

To obtain a clear understanding of structure and morphology expanded graphite and resultant defect-free graphene (also referred to as pristine graphene or “pG”), the materials are analyzed without the incorporation of silicon nanoparticles. The expansion process could be traced by scanning electron microscopy (SEM). The material has a flake width of 100 microns and a thickness of 10 - 20 microns. This corresponds to 10³ - 10⁴ layers of graphene, given an equilibrium interlayer spacing of 0.34 nm. It is recognized that the S₂O₈⁻² can greatly promote formation of H₂SO₄/graphite intercalation compound, and decompose to release gas products such as O₂ and SO₂. Under the action of the generated gas, the individual graphene interlayer are separated to form expanded graphite. It was found that major interlayer expansion results with the spacing between graphene sheets being up to microns wide. The expansion of graphite was directly visualized by the tremendous volume expansion occurring in the entire graphite platelet.

The exfoliated graphene layers possess a ruffled morphology. High resolution transmission electron microscopy (HRTEM) analysis of the graphene structure was used to determine this morpholgy. The HRTEM analysis is performed on a single sheet, with its thickness being directly measurable by the number of visible lattice fringes of the turned-up edge. Per the number of (002) lattice fringes visible at the partially curled-up edge, the highly ordered pG structure is 4 graphene monolayers thick. Fast Fourier Transform (FFT) pattern was observed. A classical hexagonal FFT pattern is indicative of a highly ordered graphene structure with minimal defects. It is distinct from the amorphous highly broadened ring patterns corresponding to the near-neighbor positions in classic reduced graphene oxide rGO or other highly defective “graphene-like” materials. Graphene defects, especially oxygen, are well-known to reduce the electrical conductivity of carbons. Importantly, chemical and structural defects such as oxygen functional groups, nanopores and edge sites are known to catalyze electrolyte decomposition on the anode, leading to accelerated and potentially unstable solid electrolyte interphase (SEI) growth. This assists in determining the cycling lifetime of the electrodes based on pG versus on rGO. The apparent height of a monolayer graphene probed by tapping-mode AFM is known to be in the range of 0.8 - 1.5nm. The graphene sheet analyzed was 5 nm, corresponding to a 3 - 5 layer graphene and consistent with the HRTEM observations.

The Si and carbon composition for Si-pG and Si-rGO was determined by thermal gravimetric analysis (TGA). The material Si-pG contains 47.8wt. % Si and 52.2 wt % C, while Si-rGO was designed to have identical silicon content. X-ray diffraction analysis of pG, Si-pG and the baseline Si-rGO materials was done. The pG and Si-pG materials show distinct (002) and (101) Bragg reflections with the equilibrium spacing for graphite. Conversely the carbon reflections in Si-rGO are highly broadened, indicative of largely disordered materials containing only short-range ordered domains of defective graphene planes. Both Si-pG and the Si-rGO display analogous Bragg (110) and (220) reflections from the crystalline silicon nanoparticles.

Raman spectroscopy analysis of pG, Si-pG and Si-rGO materials was done. The Raman spectra illustrated the key structural differences between pG, Si-pG and Si-rGO. The intensity ratio of the D-band and the G-band is utilized to quantify the degree of order in the carbon supports. The Si-pG is highly ordered showing an IG/ID ratio of 11.3, while r-GO is much more defective with an IG/ID ratio of ˜0.94. The absence of a 2D peak in r-GO is caused by the lack of long-range order, agreeing with prior studies. The observed lack of order in r-GO agrees with Hummer's derived graphene materials reported previously. Hummer's synthesized reduced graphene oxide is an amorphous matrix with nanocrystalline domains rich in residual oxygen moieties, topological defects and vacancies. Hummer's derived and related r-GO is a mixture of sp² and spa bonding, distinct from true graphene which is sp² by definition. It is useful to compare the ordering in pG to representative graphene type materials exfoliated by number of established techniques, as shown in Table 1, where prior art values were obtained through various publications.

TABLE 1
Geometry, structure and chemistry of pG and rGO as compared graphenes
prepared by various exfoliation methods from literature.

| Graphene | | | Order | | | Chemicals |
|---|---|---|---|---|---|---|
| Synthesis | Thickness | | (Raman | Heteroatoms | | involved during |
| Method | (AFM) | | I_{G}:I_{D}) | (Atomic | | Synthesis |
| p-G (current | 5 | nm | 11.3 | 4.7% | O | (NH4)₂S₂O₈, |
| invention) | | | | | | H₂SO₄, oleum |
| r-GO (made in | ~10 | nm | 0.8~1.1 | 8.1% | O | H₂SO₄, KMnO₄, |
| current study) | | | | | | Na₂NO₃, hydrazine, |
| | | | | | | H₂O₂ |
| Hummer's | Typical > | | Typical ~1 | ~10% | O | H₂SO₄, KMnO₄, |
| method | 2 nm | | | | | hydrazine/NaBH₄ |
| Exfoliation | | | | | | |
| Microwave | Statistical | | 6.6 | ~3% | | Ionic liquid, DMSO |
| Exfoliation | 90% < 1 nm | | | | | |
| Expansion- | Statistical | | ~5 | 16% O, 2% S | | (NH4)₂S₂O₈, |
| exfoliation | mean 25 | | | | | H₂SO₄, oleum |
| Sonication LPE | <5 | nm | 1-3 | 8-25% | O | Water/surfactant, |
| | | | | | | organic solvent, ionic |
| | | | | | | liquids, etc. |
| Electrochemical | 2~3 | nm | 2.38-7.1 | 5.5%-8.4% | O | (NH₄)₂SO₄, Na₂SO₄ |
| Exfoliation | | | | | | K₂SO₄ |
| | | | | | | hydrazine/NaBH₃/ |
| | | | | | | TEMPO |

The Hummer's rGO in this study display similar Raman G/D ratio to prior art. By comparison, pG shows exceptional orderliness and with minimal oxygen content.

SEM Energy Dispersive X-ray Spectroscopy (EDXS) elemental maps demonstrated the dense distribution of Si nanoparticles on the surface of pG. Based on analysis, the silicon nanoparticle surface should be terminated by hydroxyl groups (Si—OH) in aqueous solution. It is known that a Si surface can be functionalized with a layer of hydroxyl groups by oxidants like H₂O₂, which is an established strategy to improve its hydrophilicity. A similar reaction on silicon nanoparticles' surface triggered by the persulfate reagent occurs here.

X-ray photoelectron spectroscopy (XPS) analysis was performed to understand the differences in the near-surface chemistry of Si-pG versus E-Si-pG. Per the XPS results, the pG layers show the usual carbon peak at 284 eV and a relatively minor peak at 286.0 eV corresponding to C—O located at the edges of the graphene sheets. In Si 2p spectra, the oxide layer on silicon nanoparticles' surface gave a notable Si—O peak at 102.9 eV. The other two peaks at 99.6eV and 98.9eV are typically assignable to Si 2p_{1/2} and Si 2p_{3/2} of Si—Si bonds. Given that the XPS probe depth is usually less than 6 nm, the relatively intense Si—Si 2p signals indicate that the oxide is a relatively thin layer, in agreement with the HRTEM findings. Faint signals at 287.2 eV and 288.8eV are ascribable to epoxy and C═O moieties introduced by surface tethering reactions. This reaction can be more clearly seen by the substantial enhancement of the Si—O signal in Si 2p spectra; the surface silanol hydrolytic reaction introduced a considerable amount of Si—O—Si bonds. The surface modification reaction is further evidenced by the FTIR analysis. For E-Si-pG vs. Si-pG there is significantly decreased —OH absorption at ˜3420 cm⁻¹ and enhanced Si—O—Si absorption at ˜1105 cm⁻¹ of. Moreover, characteristic absorption for epoxy

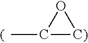

and ether groups (—C—O—C) at 910 cm⁻¹ and 1205 cm⁻¹ are present in E-Si-pG, indicating the presence of SCA molecules on the surface. SCA is possibly present on the graphene as well, per the XPS results which show enhanced levels oxygen groups. The surface epoxy groups will bond with the CMC binder (rich in carboxyl groups) through an epoxy ring-opening reaction. This reaction takes place in the electrode drying process after blade-coating the slurry onto the Cu foil current collector, making the approach compatible with prevailing electrode fabrication protocols.

### Electrochemical Performance in Half-Cell and Full Battery

A wide number of carbon supports are utilized to stabilize the cycling performance of Si nanoparticles and related materials. High surface area carbon supports and hosts can buffer the large expansion—contraction of Si, as well as serving as fast electrical and ion paths. What is not understood well, is the role of such underlying carbon support structure/chemistry in promoting stable cyclability of the entire electrode. With high surface area anode materials, early capacity decay will be primarily due to the formation of solid electrolyte interphase (SEI), as well as some irreversible trapping of ions in the bulk of the active material. SEI forms due to the irreversible reduction and chemical decomposition of the electrolyte. The solvent molecules irreversibly reduce to Li₂CO₃, Li alkyl carbonates, Li alkoxides, Li₂O and LiF. Chemical and structural defects in the carbon structure are known to catalyze SEI formation at their contact with the electrolyte. For example, in a N-doped carbon the SEI formation was observed to be more excessive near heteroatom-rich regions. However, what is not understood, is how structural and chemical defects of a carbon support affect the electrochemical behavior of the composite electrode, what is the role of support SEI formation tendency in establishing the overall electrode performance, and what happens to the electrochemical characteristics when an identical Li-active material is dispersed over two geometrically analogous carbon supports but with very different structures.

A direct electrochemical comparison of Si-pG and Si-rGO is ideally suited to address this important unexplored interdependence.

The electrochemical performance of E-Si-pG, Si-pG and baseline Si-rGO was evaluated in a half-cell configuration using CMC as the binder and Li metal as a counter electrode. The materials were tested at 100 mA g⁻¹ between 3 V-10 mV vs. Li/Li⁺. Examining cycles 1 - 10, it may be observed that the reversible capacity of E-Si-pG and Si-pG quickly stabilized after the first cycle. At cycle 1 the reversible capacity of E-Si-pG at charge and Si-pG was 1153.7 mAh g⁻¹ and 1177.4 mAh g⁻¹, respectively. At cycle 10 the reversible capacity of E-Si-pG and Si-pG was 1115.4 mAh g⁻¹ and 1155.5 mAh g⁻¹, respectively.

Conversely, at cycle 1 the reversible charge capacity of Si-rGO was 1307.5 mAh g⁻¹, while it was 1173.7 mAh g⁻¹ at cycle 10. The voltage profiles of E-Si-pG and Si-pG stabilized after the first charge, displaying overlapping charge-discharge curves in the following cycles. Going from cycle 1 to cycle 10, the Si-rGO electrode exhibited a more notable increase in voltage polarization. The different early-cycle electrochemical behavior is believed to be due to differing initial level SEI formation on E-Si-pG, Si-pG vs. Si-rGO. A thicker SEI layer irreversibly consumes more Li and more greatly increases the overpotential needed to insert/extract the ions. Single cycle irreversible capacity and accumulated capacity loss for E-Si-pG, Si-pG and Si-rGO, at cycles 1 - 10 were compared. It was found that the key difference is at cycle 1, where irreversible capacity loss for Si-rGO is 549.4 mAh g⁻¹, while for E-Si-pG, and Si-pG it is nearly half that value at -370 mAh g⁻¹. With ongoing cycling, the remaining values are on-par. This indicates that there is a tremendous difference in the levels of initial SEI formation for the structurally and chemically defective rGO vs. defect-free pG supports. It is reiterated that for both architectures the silicon nanoparticles are identical, and their respective mass loading is nearly identical. Therefore, the differences in cycle 1 capacity loss and the associated SEI levels is strictly due to the supports.

The long-term cyclability of a wide range of silicon—carbon electrodes is dictated by the ability to suppress electrode pulverization caused by the greater than 300% expansion of Si to form Li₁₅Si₄. When Si is fractured, fresh surfaces are exposed to the electrolyte and catalyze additional SEI formation. Hence there is a negative synergy: electrode fracture leads to SEI formation while the new SEI generates additional stresses that lead to more fracture, etc. 500 cycles capacity retention and CE results for E-Si-pG, Si-pG and Si-rGO were obtained, all tested at an intermediate current of 1A/g. The major differences in the cycling stability of the three electrodes may now be readily observed. The Si-rGO electrode shows by far the most rapid capacity decay, the Si-pG is intermediate, while E-Si-pG is by far the most stable. To contrast, E-Si-pG displays a highly stable capacity retention behavior being 932 m Ah/g at 500 cycles. The Si-pG decays at a slower rate than Si-rGO but still fades to 199 mAh/g at cycle 500. The associated equivalent circuit and fitting results shown in Table 2.

TABLE 2
Fitted EIS values of post 500 cycles electrodes

| | | | |
|---|---|---|---|
| Sample | R_{S} | R_{CT} | R_{SEI} |

| | | | |
|---|---|---|---|
| E-Si-pG | 3.97 | Ω | 26.1 Ω (R_{ct} + R_{SEI}) |

| | | | | |
|---|---|---|---|---|
| Si-pG | 6.0 | Ω | 37.7 Ω | 15.5 Ω |
| Si-rGO | 14.7 | Ω | 30.5 Ω | 29.0 Ω |

The diameter of two semicircles in the high and middle frequency region correlate to SEI film resistance (R_{SEI}) and charge transfer resistance (R_{CT}) respectively. The lowest R_{SEI} and R_{CT} of E-Si-pG (26.1Ω total, semicircles overlapping) indicates a thinner and more stable SEI layer than that of Si-pG (15.5Ω, 37.7Ω) and of Si-rGO (29.0Ω, 30.5Ω). A defect—free carbon support for silicon is minimize CE loss at initial cycles. However it is not enough to imbue the system with long-term cycling stability. Tailored surface chemistry is needed to hold the entire electrode together during repeated expansion—contraction. Analysis was undertake to examine the role of epoxy chemical tethers in forming SEI and thus long-term cycle stability of silicon—carbon composite.

Ar-ion beam etch depth profiling XPS spectra of the 500 cycles E-Si-pG versus the Si-pG electrodes, in the delithiated state was conducted. A total of 9 etching—analysis steps was employed, with 100 seconds of etching time per step. This resulted in a total of 10 XPS spectra generated from the electrode surface down to the bulk of electrode, although prior to reaching the current collector. Given that the etch depth of Si-based materials of Ar⁺ is about 4 nm/min, each etch step corresponds to approximately 6 nm. Evolution of the absolute Si 2p peaks with sputter depth for E-Si-pG and Si-pG, respectively, were shown. In E-Si-pG the SEI film is mainly Li₂CO₃, ROCO₂Li and other C—O and C═O species. In Si-pG, contribution of (CHF═CH₂)ₙ is also detected in addition to those species. The measured C 1S peak is a combination of the signal from adventitious carbon that is both present to begin with and is resputtered/deposited during analysis, graphene and carbon black in the electrode. The signals from the sp2 bonded carbon theoretically at 284 eV, and sp3 bonded carbon theoretically at 284.8 eV, are too close together to separate. The XPS signals for the C—C bonds are predominately from the graphene and carbon black in the electrode, with some contribution from adventitious carbon. Conversely, the carbon C—O and C—F peaks originate primarily from the SEI layer. The relative intensity of the C—O and C—F peaks vs. C—C will reflect the SEI thickness: The removal of most of the SEI layer at certain etch depth will result in the C—C bond signal becoming the major constituent in the spectra. Cycled E-Si-pG exhibits an overwhelming majority C—C peak in C 1s spectra at etch level 3. However, the cycled Si-pG always gives strong and multitudinous signals from C—O and C—F compounds even at etch level 9, indicating a much thicker SEI of Si-pG over E-Si-pG.

In the delithiated state, the Si and Li signals provide the most physically meaningful indication where the SEI ends and the active material begins. There should be no elemental or compound Si within SEI layer, and minimal Li within the active material in the de-lithiated state (apart from some Li that is irreversibly trapped). Comparing E-Si-pG and Si-pG it may be observed in E-Si-pG the intensity/concentration of Si signal is both higher in absolute terms and surpasses that of Si after 3 etch steps. This gives direct evidence that after identical number of cycles, the SEI layer in E-Si-pG is thinner. In turn this is indicative of greater structural stability due to the epoxy tethers, which prevent pulverization that leads to fresh SEI being formed.

To demonstrate the performance advantage of E-Si-pG, prototypes of full cells using E-Si-pG anode and LiCoO₂ cathodes were fabricated and tested. Comparable to prior literature studies, a pre-lithiation step was adopted to compensate for the initial capacity loss at cycle 1. Per the results, an LCO cathode with commercial mass loading of ˜12 mg/cm² was employed. The material had a reversible capacity of -150mAh/g over the potential range from 3-4.2 V vs. Li/Li⁺, corresponding to an area capacity of 1.8 mAh/cm². To balance this capacity, the E-Si-pG anode has a mass loading of 1.8 mg/cm².

In accordance to standard convention, the specific capacity is calculated based on the weight of LiCoO₂, while C rate is based on area capacity of cathode, with 1 C=1.8 mA cm⁻². At a discharge rate of 0.1 C, the full cell delivered a reversible capacity of 1.87 mAh cm⁻² with average working voltage of 3.9V. The resultant specific energy is 523 Whkg⁻¹ based on the total mass of LiCoO₂ and E-Si-pG. Furthermore, capacities of 1.75, 1.62, 1.48 and 1.32 mAh cm⁻² and average working voltages of 3.77, 3.58, 3.47, 3.41 V at high current densities (0.2, 0.4, 0.6, 1 C) are measured, corresponding to 484.1, 437, 390.9, 340.4 Wh kg⁻¹, respectively. Extended cycling of the full cell was also conducted at 1 C, with charge current density limited to 0.5 C given the sluggish kinetics of LCO and possible Li plating at higher C-rate. After 150 cycles, an area capacity of 1.26 mAh cm⁻² and energy density of 306.5 Wh kg⁻¹ were retained, suggesting excellent cycle life of the E-Si-pG II LCO full cell configuration.

Table 3 compares the electrochemical performance of full E-Si-pG vs. LiCoO₂ cells employed here versus state-of-the art literature for full cells based on other Si anode architectures disclosed in the literature.

TABLE 3
A broad performance comparison of Si-pG-E || LiCoO₂ devices versus
state-of-the-art full devices from literature employing Si anodes.

| | | Half-cell vs. Li/Li⁺ | | |
|---|---|---|---|---|
| | | Capacity | Full Cell Battery | |
| Material type | | (retention@cycle | Cathode | Specific |
| (Si content wt %) | Synthesis strategy | number-current density) | (area capacity) | Energy |
| E-Si-pG | silicon - pristine | 932 mAh g⁻¹ | LiCoO₂ | 523 Wh/kg |
| this study | graphene hybrid + | (88.3%@500 cycle-1 A/g) | (1.8 mAh cm⁻²) | (based on |
| (47.8%) | silane coupling | | | cathode + |
| | | | | anode) |
| Si/Graphite/ | self-assembly and | 502.2 mAh g⁻¹ | LiFePO₄ | NA |
| Grphene composite | annealing (900° C.) | (92%@ 600 cycle-0.8 C) | (~1 mAh cm⁻²) | |
| (8%) | | | | |
| Si-graphene | CVD grown Si on r-GO | 1103 mAh/g | LiCoO₂ | 468 Wh/kg |
| hybrid (82%) | (550° C.) | (@1000 cycle-2.8 A/g) | (0.71 mAh cm⁻²) | |
| graphene/ | Layer-by-layer | 1251 mA h g⁻¹ | LiCoO₂ | rapidly |
| nanocellulose/ | assembly + crosslinking + | (@ 100 cycle-0.1 A/g) | (NA) | decay |
| silicon | hydrazine vapor | | | |
| hybrid (68%) | reduction | | | |
| Double-C | CVD + | 1355 mA h g⁻¹ | LiNi_{0.45}Co_{0.1} | 474 Wh/kg |
| coated Si | magnesiothermic | (75.2%@1000 cycle-0.84 A/g) | Mn_{1.45}O₄ | |
| (70.5%) | reduction + HCl washing | | (~1.3 mAh cm⁻²) | |
| Silicon/porous | Hydrothermal | 1070 mA h g⁻¹ | LiNi_{0.5}Co_{0.2} | 504 Wh/kg |
| carbon spheres | (200° C., 10 h) + | (93.5%@500 cycle-0.8 A/g) | Mn_{0.2}O₄ | |
| (30%) | carbonization | | (~1.4 mAh cm⁻²) | |
| | (750° C., 5 h) | | | |
| Carbon-coated | Magnesiothermic | 1575.5 mAh g⁻¹ | LiCoO₂ | 416 Wh/kg |
| Si nanosheets | reduction (650° C.), HF | (92%@100 cycles-0.4 A/g) | (~2 mAh cm⁻²) | |
| (N/A) | leaching, | | | |
| | hydrothermal (24 h) + | | | |
| | Carbonization | | | |
| N-doped | Magnesiothermic | ~900 mAh g⁻¹ | LiCoO₂ | 329 Wh/kg |
| Graphene-Si | reduction + CVD | (~50%@200 cycle-1 A/g) | (~0.4 mAh cm⁻²) | |
| (N/A) | 650° C. | | | |
| Hierarchical | Carbonization, | 1015 mA h g⁻¹ | LiCoO₂ | 486 Wh/kg |
| Carbon-Coated Si | calcination | (63.6%@100 cycle-0.4 A/g) | And | (based on |
| (95.2%) | (900° C.) | | LiNi_{0.5}Mn_{1.5}O₄ | LCO) |
| | | | (~1.3 mAh cm⁻²) | 547 Wh/kg |
| | | | | (based on |
| | | | | LNMO) |
| Mxene/Si@SiO@C | Magnesiothermic | 390 mAh g⁻¹ | LiNi_{0.5}Co_{0.2}Mn_{0.2}O₂ | 485 |
| superstructure | reduction, | (76.41@1000cycle-42 A/g) | (~0.13 mAh cm⁻²) | Wh/kg |
| | carbonization | | | bsed |
| | | | | on NCM) |

It may be observed that E-Si-pG vs. LiCoO₂ is quite favorable in terms of all relevant parameters; it's a uniquely high mass loading system that has excellent energy, cyclability and rate capability.

The key importance of utilizing pristine “defect-free” graphene, rather than conventional graphene such as Hummer's r-GO, is that the former minimizes solid electrolyte interphase (SEI) formation that in turn drives cycling-induced capacity decay. A direct relation between carbon host chemical and structural defectiveness and electrode cyclability has not been reported in prior studies of hosted alloying reaction anode materials. The role of epoxy chemical tethers is explored in detail using sputter-down XPS analysis of the cycled electrodes. The Epoxy-tethered Silicon pristine-Graphene hybrid (E-Si-pG) exhibits excellent electrochemical performance, both as a high-rate half-cell vs. Li/Li⁺ and as a full cell battery with near-commercial mass loading of 12 mg cm⁻² for the LiCoO₂ cathode. Per a systematic comparison as shown above, it is concluded that this is among the most favorable energy—power—cyclability combinations reported for a full cell at commercial mass loadings.

### Synthesis of Defect-Free Graphene Material

Flake graphite, silicon nanoparticles (-50nm) and γ-(2,3-epoxypropoxy) propytrimethoxy silane (SCA) were received from Aladdin Chemicals. Sulfuric acid, oleum and ammonium per sulfate were supplied by Kelong Chemicals. LiCoO₂, carboxymethyl cellulose sodium (CMC) and Poly(vinylidene fluoride) (PVDF) powder were supplied by MTI Group. All chemicals are received as is without any further purification. A non-oxidative expansion chemistry was employed to create the expanded graphite used as a precursor for Silicon pristine-Graphene hybrid “Si-pG” and Epoxy-tethered Silicon pristine-Graphene hybrid “E-Si-pG”. In a typical experimental run, 6 g of (NH₄)₂S₂O₈ was added to a sealed beaker containing 48 mL of acid solution (98% H₂SO₄/Oleum=1:1 v/v), and then kept stirring until the salt completely dissolved. Then 0.3 g of graphite powder was step-wise added into the beaker, which was transferred to a 60° C. water bath and kept at continuing stirring. After several minutes, 0.3 g of nano-silicon powder was added to beaker with constant magnetic stirring lasted for 1 hr. After repeated rinsing and filtration with deionized water, the obtained material was re-dispersed into isopropanol aqueous solution (30 vol %) to form uniform suspension. The suspension was quenched by liquid nitrogen, then freeze dried to obtain the final Si-pG powder. Pristine graphene (pG) was also obtained by an identical procedure but without adding Si nanoparticles. An intimate physical mixture of pG and Silicon nanoparticles termed “Si-pG-mix” was prepared by extended blending pG and Si nanoparticles using mortar and pestle. The baseline r-GO synthesis is performed via a standard Hummer's route, the details being given in the Supplemental.

To activate the Silane Coupling Agent (SCA), the following approach was employed: Glacial acetic acid was firstly added to 100 mL of solution of ethanol aqueous solution (90 vol %) to adjust pH to 5.5. Then 3 mL of γ-(2,3-epoxypropoxy) propytrimethoxy silane was drop-wised added and subjected to intermittent manual shaking at room temperature for ˜15 minutes. After the siloxy hydrolysis was complete, an activated-SCA solution is ready for use. The epoxy functionalization to create E-Si-pG was based on the following approach. A 1.5 mL activated-SCA solution was mixed with 100 mg S-pG powder and then annealed at 80° C. under vacuum for 4 hour. During the annealing process, surface coupling reaction between Si-pG and SCA took place to yield E-Si-pG, ready for electrode slurry preparation. When the finished electrodes are dried under vacuum at 120° C. for 24 hours, the epoxy functional groups in E-Si-pG react with the carboxymethyl cellulose sodium (CMC) binder to form 3-dimentional cross linked networks.

### Analytical and Electrochemical Characterization

Fourier Transform infrared spectroscopy (FTIR) was performed using a Thermo Scientific Nicolet 7600IR spectrometer. Raman spectroscopy was carried out using a Horriba LabRAM HR, equipped with a 532 nm laser. Thermal gravimetric analysis (TGA) was performed on a Netzsch STA-449 F3 under air atmosphere (30˜1000°, 10°/min). The morphology and structure of the samples was analyzed by Field Emission Scanning Electron Microscopy (FESEM, JSM-7500F operated at 15 kV), atomic force microscopy (AFM, Bruker Multimode 8 in tapping mode) and transmission electron microscopy (TEM, Tecnai G2-F20 operated at 200 kV). AFM and TEM specimens were fabricating by casting a drop of graphene ink (dispersed in isopropanol) onto freshly cleaved mica substrate and lacey carbon copper grid respectively. Near surface chemistry characterization was based X-ray photoelectron spectroscopy (XPS, ThermoFisher EScalab 250Xi with Al Ka radiation). An Ar⁺ beam with beam energy of 1 kV and beam current of 0.5 pA was employed for depth profiling. XPS Peak fitting was performed using Gaussian/Lorentzian peak shapes following subtraction of Shirley background.

The obtained active anode material, carbon black (CB) and CMC were mixed in a mass ratio of 6:2:2 and grinded in a mortar to obtain uniform slurry. Then the slurry was blade-coated on a copper foil with an electrode material mass loading of ˜1 mg. For full cells, mass loading was tuned up to 3 mg. For full cell investigation, the silicon anode was firstly pre-lithiated by direct compressing it onto an electrolyte wetted lithium foil (shorted), and then paired with lithium cobalt oxide (LiCoO₂, MTI group) cathodes. The LiCoO₂ cathode was prepared by mixing LiCoO₂ powder with polyvinylidene diflouride (PVDF) and CB in N-Methyl pyrrolidone (NMP) with a weight ratio of 8:1:1, and coated the slurry on aluminum foil with active material mass loading of ˜12 mg/cm². The cathode area capacity tested with Li metal as counter electrode was ˜1.8 mAh/cm² and the capacity ratio of anode to cathode (N/P ratio) was controlled at ˜1.1 to 1.

The electrodes were punched into discs and assembled into 2025-type coin cell batteries in an argon-filled glovebox with oxygen and moisture content lower than 0.1 ppm. Celgard 2400 membrane was employed as a separator and a lithium foil (800 microns thick, China Energy Lithium Co., Ltd) was used as a counter electrode in the half-cells. 1 M LiPF6 dissolved in a 1:1:1 (volume ratio) mixture of ethylene carbonate (EC), ethyl methyl carbonate (EMC) and diethyl carbonate (DEC) with 5 vol. % fluoroethylene carbonate (FEC) was used as the electrolyte. The galvanostatic charge-discharge cycling tests were performed on LAND-CT2001A battery tester at voltage window of 3 - 10 mV vs. Li/Li⁺ with current density of 100 mA/g. Prior to extended cycling at 1 A/g, a formation protocol of 3 galvanostatic cycles at 100 mA/g was adopted to stabilize the SEI. Electrochemical impedance spectroscopy (EIS) tests were carried out using AUTOLAB M204 (Metrohm, Switzerland). The frequency range was set at 0.1 Hz-1 MHz with an AC amplitude of 5 mV. All Nyquist plots were fitted and then normalized to zero starting point, to better highlight changes of charge transfer resistance and SEI resistance.

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about”. The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A material for use as an electrode in an electrochemical storage device, the material comprising:
at least one layer of defect-free graphene;
an active phase proximate at least one surface of the at least one layer of defect-free graphene; and
a binder system,
wherein at least one of:
(a) the at least one layer of defect-free graphene is attached to the active phase,
(b) the active phase is attached to the binder system, and
(c) the defect-free graphene is attached to the binder system.

2. The material according to claim 1, further comprising two layers of defect-free graphene.

3. The material according to claim 2, further comprising the active phase on a first surface of a first layer of defect-free graphene, the first surface opposite a second surface of a second layer of defect-free graphene, such that the active phase is positioned between the two layers of defect-free graphene.

4. The material of claim 1, further comprising three layers of defect-free graphene.

5. The material of claim 4, wherein the active phase is on:
(a) a first surface of a first layer of defect-free graphene, the first surface opposite a second surface of a second layer of defect-free graphene, such that the active phase is positioned between the first layer of defect free graphene and the second layer of defect-free graphene; and
(b) a third surface of the second layer of defect-free graphene, the third surface opposite a fourth surface of a third layer of defect-free graphene, such that the active phase is positioned between the second layer of defect-free graphene and the third layer of defect-free graphene.

6. The material according to claim 1, wherein the active phase comprises a plurality of active nanoparticles.

7. The material according to claim 6, wherein the active nanoparticles are selected from the group consisting of silicon, germanium, metals, sulfides, phosphides, selenides, nitrides, oxides, and ceramics.

8. The material according to claim 7, wherein the active nanoparticles are silicon nanoparticles.

9. The material of claim 8, wherein the plurality of silicon nanoparticles are present at a mass loading of at least 47%.

10. The material of claim 1, wherein the binder system is selected from the group consisting of carboxymethyl cellulose, alginate, polyacrylic acid, Polyvinylidene fluoride (PVDF) and Styrene-Butadiene Rubber.

11. A method for making an active phase-containing defect-free graphene material, the method comprising:
providing graphite to a non-oxidative exfoliation process to obtain expanded graphite; and
simultaneously during the exfoliation process, introducing an active phase to form an active phase-containing defect-free graphene material.

12. The method according to claim 11, wherein the active phase comprises a plurality of active nanoparticles.

13. The method according to claim 12, wherein the active nanoparticles are selected from the group of consisting of silicon, germanium, metals, sulfides, phosphides, selenides, nitrides, oxides, and ceramics.

14. The method according to claim 13, wherein the active nanoparticles are silicon nanoparticles.

15. The method according to claim 14, wherein the plurality of silicon nanoparticles are present at a mass loading of at least 47%.

16. The method according to claim 11, further comprising a subsequent step of adding a binder system to the active phase-containing defect-free graphene material.

17. The method according to claim 16, further comprising a subsequent step of adding a silane surface treatment.

18. The method according to claim 16, wherein the silane surface treatment attaches:
(a) the at least one layer of defect-free graphene is attached to the active phase,
(b) the active phase is attached to the binder system, and
(c) the defect-free graphene is attached to the binder system.
